(19) United States
(12) Patent Application Publication
(10) Pub. No.: US 2020/0391605 A1
(43) Pub. Date: Dec. 17, 2020

(54) MANAGEMENT DEVICE, MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/889,956

(22) Filed: Jun. 2, 2020

(30) Foreign Application Priority Data
Jun. 6, 2019 (JP) 2019-106517

(51) Int. Cl. B60L 53/60; B60L 50/60; B60L 58/10; G08G 1/14

(52) U.S. Cl. CPC B60L 53/60; B60L 50/60; B60L 2240/54; G08G 1/143; B60L 58/10

(57) ABSTRACT

A management device includes: an acquirer configured to acquire information indicating remaining energy amounts of vehicles parked in a parking lot; a determiner configured to determine a remaining energy amount of a vehicle parked in the parking lot so that a sum of the acquired remaining energy amounts is equal to or greater than a predetermined value; and a replenisher configured to replenish energy of the parked vehicle based on the remaining energy amount determined by the determiner.

### CROSS-REFERENCE TO RELATED APPLICATION

Priority is claimed on Japanese Patent Application No. 2019-106517, filed Jun. 6, 2019, the content of which is incorporated herein by reference.

### BACKGROUND

### Field of the Invention

The present invention relates to a management device, a management method, and a storage medium.

### Description of Related Art

In recent years, studies of automated vehicle control have been conducted. As a technology using this control, for example, a charging and discharging facility controlled such that remaining battery amount information is acquired from a vehicle parked in a parking lot, discharging power is discharged from a battery of one vehicle among a plurality of vehicles, and power supply based on the discharged discharging power is received by a battery of another vehicle is known (for example, Japanese Unexamined Patent Application, First Publication No. 2012-257436).

### SUMMARY

In the technology of the related art, however, a total amount of energy of vehicles located in a parking lot has not been sufficiently examined

The present invention is devised in view of such circumstances and an objective of the present invention is to provide a management device, a management method, and a storage medium capable of managing charging and discharging of a vehicle in consideration of a total amount of energy of vehicles located in a parking lot.

A management device, a management method, and a storage medium according to the present invention adopt the following configurations.

(1) According to an aspect of the present invention, a management device includes: an acquirer configured to acquire information indicating remaining energy amounts of vehicles parked in a parking lot; a determiner configured to determine a remaining energy amount of a vehicle parked in the parking lot so that a sum of the acquired remaining energy amounts is equal to or greater than a predetermined value; and a replenisher configured to replenish energy of the parked vehicle based on the remaining energy amount determined by the determiner.

(2) In the management device according to the aspect (1), the predetermined value may be a value with which the management device is able to operate by supplying energy from the vehicle parked in the parking lot to the management device when the management device guides the vehicle parked in the parking lot in a state in which supply power from a power system is stopped.

(3) In the management device according to the aspect (1), the predetermined value may be a value with which each of the vehicles parked in the parking lot is able to exit the parking lot and travel when energy related among the predetermined value is distributed to the vehicles parked in the parking lot.

(4) In the management device according to the aspect (1), the determiner may determine the predetermined value based on the number of vehicles parked in the parking lot.

(5) The management device according to the aspect (1) may further include a controller configured to control a charging and discharging device based on the remaining energy amount determined by the determiner. The charging and discharging device may be connected to the power system and may be able to receive and transmit power to and from the vehicles parked in the parking lot.

(6) In the management device according to the aspect (5), the controller may control the charging and discharging device such that power with which a battery of a first vehicle is charged is acquired when the supply of the power from the power system is stopped. The management device may perform a process of guiding the vehicles parked in the parking lot and causing the vehicles to exit using the acquired power.

(7) In the management device according to the aspect (5), the controller may control the charging and discharging device such that a battery of a second vehicle is charged with power with which a battery of a first vehicle is charged when the supply of the power from the power system is stopped.

(8) In the management device according to the aspect (6), the determiner may determine the first vehicle in order from a vehicle with a longer which a parking time.

(9) According to another aspect of the present invention, there is provided a management method causing a computer to perform: acquiring information indicating remaining energy amounts of vehicles parked in a parking lot; determining a remaining energy amount of a vehicle parked in the parking lot so that a sum of the acquired remaining energy amounts is equal to or greater than a predetermined value; and replenishing energy of the parked vehicle based on the remaining energy amount determined by the determiner.

(10) According to still another aspect of the present invention, a non-transitory computer-readable storage medium stores a program causing a computer to perform: acquiring information indicating remaining energy amounts of vehicles parked in a parking lot; determining a remaining energy amount of a vehicle parked in the parking lot so that a sum of the acquired remaining energy amounts is equal to or greater than a predetermined value; and replenishing energy of the parked vehicle based on the remaining energy amount determined by the determiner.

According to the aspects (1) to (10), it is possible to manage charging and discharging of a vehicle in consideration of a total amount of energy of vehicles located in a parking lot.

### BRIEF DESCRIPTION OF THE DRAWINGS

FIG. 1 is a diagram illustrating a configuration of a vehicle system in which a vehicle control device according to an embodiment is used.

FIG. 2 is a diagram illustrating a functional configuration of a first controller and a second controller.

FIG. 3 is a diagram schematically illustrating a scenario in which an autonomous parking event is performed.

FIG. 4 is a diagram illustrating an example of a configuration of a parking lot management device.

FIG. 5 is a diagram illustrating an example of first energy management information.

FIG. 6 is a diagram illustrating an example of second energy management information.

FIG. 7 is a diagram illustrating an example of a parking situation (part 1) of a parking lot.

FIG. 8 is a diagram illustrating an example of a parking situation (part 2) of the parking lot.

FIG. 9 is a diagram illustrating an example of a parking situation (part 3) of the parking lot.

FIG. 10 is a diagram illustrating an example of an entering process by the parking lot management device. FIG. 11 is a diagram illustrating an example of a charging process by the parking lot management device.

FIG. 12 is a diagram illustrating an example of movement of a vehicle when power supply is stopped.

FIG. 13 is a diagram illustrating an example of a charging process by the parking lot management device.

FIG. 14 is a diagram illustrating another example of the movement of the vehicle when the power supply is stopped.

FIG. 15 is a diagram illustrating another example of the charging process by the parking lot management device.

FIG. 16 is a diagram illustrating an example of a hardware configuration of an automated driving control device according to an embodiment.

### DESCRIPTION OF EMBODIMENTS

### First Embodiment

Hereinafter, embodiments of a management device, a management method, and a storage medium according to the present invention will be described with reference to the drawings.

### [Overall Configuration]

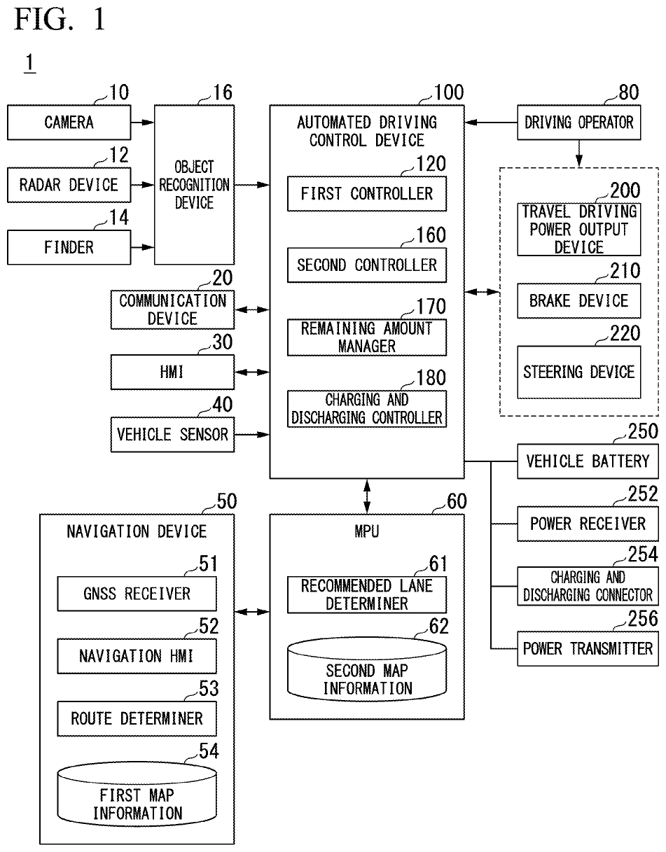

FIG. 1 is a diagram showing a configuration of a vehicle system 1 in which a vehicle control device according to an embodiment is used. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, or a combination thereof. The electric motor operates using power generated by a power generator connected to the internal combustion engine or power discharged from a secondary cell or a fuel cell.

The vehicle system 1 includes, for example, an camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving power output device 200, a brake device 210, a steering device 220, a vehicle battery 250, a power receiver 252, a charging and discharging connector 254, and a power transmitter 256. The devices and units are connected to one another via a multiplex communication line such as a controller area network (CAN) communication line, a serial communication line, or a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of a vehicle in which the vehicle system 1 is mounted (hereinafter referred to as an own vehicle M). When the camera 10 images a front side, the camera 10 is mounted on an upper portion of a front windshield, a rear surface of a rearview mirror, or the like. For example, the camera 10 repeatedly images the surroundings of the own vehicle M periodically. The camera 10 may be a stereo camera or an omnidirectional camera.

The radar device 12 radiates radio waves such as millimeter waves to the surroundings of the own vehicle M and detects radio waves (reflected waves) reflected from an object to detect at least a position (a distance from and an azimuth of) of the object. The radar device 12 is mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 radiates light to the surroundings of the own vehicle M and measures scattered light. The finder 14 detects a distance to a target based on a time from light emission to light reception. The radiated light is, for example, pulsed laser light. The finder 14 is mounted on any portions of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving control device 100. The object recognition device 16 may output detection results of the camera 10, the radar device 12, and the finder 14 to the automated driving control device 100 without any change. The object recognition device 16 may be excluded from the vehicle system 1.

The communication device 20 communicates with another vehicle around the own vehicle M, the parking lot management device (to be described below), or various server devices by using, for example, a cellular network, a Wi-Fi network, Bluetooth (registered trademark), dedicated short range communication (DSRC) or the like.

The HMI 30 presents various types of information to occupants of the own vehicle M and receives input operations by the occupants. The HMI 30 includes various display devices, speakers, buzzers, touch panels, switches, and keys. The HMI 30 may receive an instruction from a user through a manual operation by a user or may recognize a voice of the user and receive an instruction from the user.

The vehicle sensor 40 includes a vehicle speed sensor that detects a speed of the own vehicle M, an acceleration sensor that detects acceleration, a yaw rate sensor that detects angular velocity around a vertical axis, and an azimuth sensor that detects a direction of the own vehicle M. The vehicle sensor 40 includes a charging detection sensor that detects charging (start or end of charging) to the vehicle battery 250, a power detection sensor detecting that the power receiver 252 receives power, and a connection detection sensor that detects a connection state between the charging and discharging connector 254 and a charging plug of a charging and discharging facility. The vehicle sensor 40 may include a remaining battery amount detector or a remaining fuel detector that detects a state of charge (SOC) of a secondary cell that supplies power to an electric motor which is a driving source included in the own vehicle M. The remaining fuel detector detects, for example, a remaining amount of fuel (gasoline) which is used for combusting an internal combustion engine included in the own vehicle M or a remaining fuel amount (for example, hydrogen, hydrocarbon, or alcohol) which is used to generate power of a fuel cell. In the following description, when a secondary cell and a fuel cell are not distinguished from each other, the secondary cell and the fuel call are referred to as a battery. A result detected by the vehicle sensor 40 is output to the automated driving control device 100.

The navigation device 50 includes, for example, a global navigation satellite system (GNSS) receiver 51, a navigation HMI 52, and a route determiner 53. The navigation device 50 retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented for by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 (hereinafter referred to as a route on a map) with reference to the first map information 54. The first map information 54 is, for example, information in which a road shape is expressed by links indicating roads and nodes connected by the links. The first map information 54 may include a curvature of a road and point of interest (POI) information. The route on the map is output to the MPU 60. The navigation device 50 may perform route guidance using the navigation HMI 52 based on the route on the map. The navigation device 50 may be realized by, for example, a function of a terminal device such as a smartphone or a tablet terminal possessed by an occupant. The navigation device 50 may transmit a present position and a destination to a navigation server via the communication device 20 to acquire the same route as the route on the map from the navigation server.

The MPU 60 includes, for example, a recommended lane determiner 61 and retains second map information 62 in a storage device such as an HDD or a flash memory. The recommended lane determiner 61 divides the route on the map provided from the navigation device 50 into a plurality of blocks (for example, divides the route in a vehicle movement direction for each 100 [m]) and determines a recommended lane for each block with reference to the second map information 62. The recommended lane determiner 61 determines in which lane the vehicle travels from the left. When there is a branching location in the route on the map, the recommended lane determiner 61 determines a recommended lane so that the own vehicle M can travel in a reasonable route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently by communicating with another device using the communication device 20.

The driving operator 80 includes, for example, an accelerator pedal, a brake pedal, a shift lever, a steering wheel, a heteromorphic steering wheel, a joystick, and other operators. A sensor that detects whether there is an operation or an operation amount is mounted in the driving operator 80 and a detection result is output to the automated driving control device 100 or some or all of the travel driving power output device 200, the brake device 210, and the steering device 220.

The automated driving control device 100 includes, for example, a first controller 120, a second controller 160, a remaining amount manager 170, and a charging and discharging controller 180. Each of the first controller 120 and the second controller 160 is realized, for example, by causing a hardware processor such as a central processing unit (CPU) to execute a program (software). Some or all of the constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device (a storage device including a non-transitory storage medium) such as an HDD or a flash memory of the automated driving control device 100 or may be stored in a detachably mounted storage medium such as a DVD, a CD-ROM, or the like so that the storage medium (a non-transitory storage medium) is mounted on a drive device to be installed on the HDD or the flash memory of the automated driving control device 100.

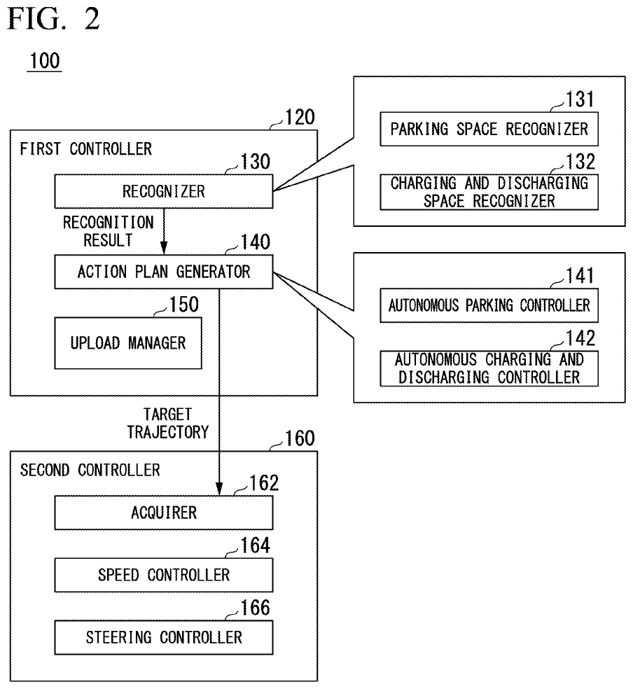

FIG. 2 is a diagram illustrating a functional configuration of the first controller 120 and the second controller 160. The first controller 120 includes, for example, a recognizer 130, an action plan generator 140, and an upload manager 150. The first controller 120 realizes, for example, a function by artificial intelligence (AI) and a function by a model given in advance in parallel. For example, a function of “recognizing an intersection” may be realized by performing recognition of an intersection by deep learning or the like and recognition based on a condition given in advance (a signal, a road sign, or the like which can be subjected to pattern matching) in parallel, scoring both the recognitions, and performing evaluation comprehensively. Thus, reliability of automated driving is guaranteed.

The recognizer 130 recognizes states such as a position, a speed, acceleration, or the like of an object near the own vehicle M based on information input from the camera 10, the radar device 12, and the finder 14 via the object recognition device 16. For example, the position of the object is recognized as a position on the absolute coordinates in which a representative point (a center of gravity, a center of a driving shaft, or the like) of the own vehicle M is the origin and is used for control. The position of the object may be represented as a representative point such as a center of gravity, a corner, or the like of the object or may be represented as expressed regions. A “state” of an object may include acceleration or jerk of the object or an “action state” (for example, whether a vehicle is changing a lane or is attempting to change the lane).

The recognizer 130 recognizes, for example, a lane in which the vehicle M is traveling (a traveling lane). For example, the recognizer 130 recognizes the traveling lane by comparing patterns of road mark lines (for example, arrangement of continuous lines and broken lines) obtained from the second map information 62 with patterns of road mark lines around the vehicle M recognized from images captured by the camera 10. The recognizer 130 may recognize a traveling lane by recognizing runway boundaries (road boundaries) including road mark lines or shoulders, curbstones, median strips, and guardrails without being limited to road mark lines. In this recognition, the position of the own vehicle M acquired from the navigation device 50 or a process result by INS may be added. The recognizer 130 recognizes temporary stop lines, obstacles, red signals, toll gates, and other road events.

The recognizer 130 recognizes a position or a posture of the own vehicle M in the traveling lane when the recognizer 130 recognizes the traveling lane. For example, the recognizer 130 may recognize a separation from the middle of a lane of a standard point of the own vehicle M and an angle formed with a line extending along the middle of a lane in the movement direction of the own vehicle M as a relative position and posture of the own vehicle M to the traveling lane. Instead of this, the recognizer 130 may recognize a position or the like of the standard point of the own vehicle M with respect to any side end portion (a road mark line or a road boundary) of a traveling lane as the relative position of the own vehicle M to the traveling lane.

The recognizer 130 includes, for example, a parking space recognizer 131 and a charging and discharging space recognizer 132. This configuration is activated in an autonomous parking event to be described below. The details thereof will be described later.

The upload manager 150 uploads various types of information acquired in the own vehicle M to the parking lot management device 400. For example, the upload manager 150 transmits information indicating a remaining energy amount of the vehicle battery 250 acquired by the remaining amount manager 170 to the parking lot management device 400 by using the communication device 20.

The action plan generator 140 generates a target trajectory along which the own vehicle M travels in future automatedly (irrespective of an operation or the like by a driver) so that the own vehicle M is traveling along a recommended lane determined by the recommended lane determiner 61 and can handle a surrounding situation of the own vehicle M in principle. The target trajectory includes, for example, a speed component. For example, the target trajectory is expressed by arranging spots (trajectory points) at which the own vehicle M will arrive in sequence. The trajectory point is a spot at which the own vehicle M will arrive for each predetermined traveling distance (for example, about several [m]) in a distance along a road. Apart from the trajectory points, target acceleration and a target speed are generated as parts of the target trajectory for each of predetermined sampling times (for example, about every fractions of a second). The trajectory point may be a position at which the own vehicle M will arrive at the sampling time for each predetermined sampling time. In this case, information regarding the target acceleration or the target speed is expressed according to an interval between the trajectory points.

The action plan generator 140 may set an automated driving event when the target trajectory is generated. As the automated driving event, there are an autonomous parking event, a low-speed following traveling event, a lane changing event, a branching event, a joining event, a takeover event, an autonomous parking event in which unmanned travel parking is performed in valet parking, and the like. The action plan generator 140 generates the target trajectory in accordance with an activated event.

Of autonomous parking events, an event in which automated parking and automated return are performed through guiding of the parking lot management device 400 is referred to as an autonomous parking event below. The automated parking includes an operation in which a vehicle enters an entrance of a parking lot and travels to a parking space through guided automated driving and an operation in which a vehicle parks in a parking space through guided automated driving. The automated return is an operation in which a vehicle travels to an exit of a parking lot and leaves from the parking lot, and then the vehicle parks in an area in which an occupant is allowed to board (for example, a stopping area 310 to be described below) through guided automated driving. In the guided automated driving, for example, the own vehicle M moves while performing sensing by itself along a route guided by the parking lot management device 400.

When there is a charging request, the action plan generator 140 may set an autonomous charging event. When there is a discharging request, the action plan generator 140 may set an autonomous discharging event. In the autonomous charging event, the unmanned own vehicle M travels and parks in a charging and discharging space in valet parking or the like and a battery of the own vehicle M is charged with power supplied from a charging and discharging device installed in the charging and discharging space. In the autonomous discharging event, the own vehicle M moves to the charging and discharging space from a waiting state in the parking space and the power of the battery of the own vehicle M is discharged in the charging and discharging device installed in the charging and discharging space.

For example, the own vehicle M heads for the charging and discharging space and the charging is completed earlier before the own vehicle M parks in the parking space PS. After the charging is completed, the own vehicle M heads for the parking space PS and parks in the parking space PS. This example will be described later. However, the present invention is not limited thereto. The own vehicle M may head for the charging and discharging space and may be charged after the own vehicle M parks in the parking space PS. When there is a discharging instruction from the parking lot management device 400 during parking, the own vehicle M may depart from the parking space PS and head for the charging and discharging space.

In the parking lot, for example, one or more charging and discharging devices are installed, and charging and discharging spaces are set near the charging and discharging devices. The details thereof will be described later.

The parking lot management device 400 is an example of a management device that manages a parking lot and a management target is not limited to the parking lot. For example, any facility may be used as long as a plurality of vehicles pass through the two or more same spots in the facility.

Hereinafter, an example in which the parking lot management device 400 generates a rough traveling route based on a map in the parking lot in guided automated driving and the own vehicle M generates a target trajectory based on the traveling route generated by the parking lot management device 400 in guided automated driving will be described. The rough traveling route includes, for example, a traveling distance of each section to a target, a turning direction (a right turn, a left turn, or the like), and positional information on a map of the parking lot and indicates a route for traveling to the destination with reference to the information. For example, a route in which a vehicle advances OO meters in a xx passage and turns left, turns left at a predetermined spot in a parking lot map, or the like is included.

The present invention is not limited thereto. The parking lot management device 400 may generate a target trajectory and the own vehicle M may travel along the target trajectory generated by the parking lot management device 400 through guided automated driving. Here, in the following description, as described above, it is assumed that the parking lot management device 400 generates a rough traveling route and the own vehicle M generates a target trajectory.

The action plan generator 140 includes, for example, an autonomous parking controller 141 and an autonomous charging and discharging controller 142 activated when an autonomous parking event is performed. The details of functions of these constituent elements will be described later.

The second controller 160 controls the travel driving power output device 200, the brake device 210, and the steering device 220 so that the own vehicle M passes along the target trajectory generated by the action plan generator 140 at a scheduled time.

The second controller 160 includes, for example, an acquirer 162, a speed controller 164, and a steering controller 166. The acquirer 162 acquires information regarding a target trajectory (trajectory points) generated by the action plan generator 140 and stores the information in a memory (not shown). The speed controller 164 controls the travel driving power output device 200 or the brake device 210 based on a speed element incidental to the target trajectory stored in the memory. The steering controller 166 controls the steering device 220 in accordance with a curve state of the target trajectory stored in the memory. Processes of the speed controller 164 and the steering controller 166 are realized, for example, by combining feed-forward control and feedback control. For example, the steering controller 166 performs the feed-forward control in accordance with a curvature of a road in front of the own vehicle M and the feedback control based on separation from the target trajectory in combination.

Referring back to FIG. 1, the remaining amount manager 170 ascertains a state of the vehicle battery 250 and monitors inputting and outputting power to and from the vehicle battery 250. For example, the remaining amount manager 170 acquires a remaining electric energy amount of the vehicle battery 250. Specifically, for example, the remaining amount manager 170 measures a terminal voltage of the vehicle battery 250 and acquires a remaining electric energy amount based on magnitude of the measured terminal voltage. For example, the remaining amount manager 170 may acquire a remaining electric energy amount by integrating a current amount stored at the time of charging using a current detection resistor and obtaining a current amount output at the time of discharging. The remaining amount manager 170 may store a database such as discharging characteristics or temperature characteristics of the vehicle battery 250 in a storage (not illustrated) or the like in advance and acquire a remaining electric energy amount based on a measured voltage value or current value and the database. The remaining amount manager 170 may combine some or all of the above-described acquisition schemes. The remaining amount manager 170 may acquire a ratio of the above-described remaining electric energy amount to an amount of full electric energy (for example, a charging ratio: state of charge (SOC)). The remaining amount manager 170 may perform cooling management of the vehicle battery 250, monitoring of a high-voltage safety circuit (not illustrated), or the like.

The charging and discharging controller 180 controls charging and discharging of the vehicle battery 250. For example, when the power receiver 252 receives power, the vehicle battery 250 is charged. When a discharging instruction is given from the parking lot management device 400 or the charging and discharging device 340, the power transmitter 256 is used to transmit power of the vehicle battery 250 to the charging and discharging device 340.

The travel driving power output device 200 outputs a travel driving power (torque) for traveling the vehicle to a driving wheel. The travel driving power output device 200 includes, for example, a combination of an internal combustion engine, an electric motor, and a transmission and an electronic control unit (ECU) controlling them. The ECU controls the foregoing configuration in accordance with information input from the second controller 160 or information input from the driving operator 80. When the own vehicle M is traveling using the power supplied from the vehicle battery 250, the travel driving power output device 200 may include a traveling motor and a motor ECU. The motor ECU controls driving of the traveling motor using power supplied from the vehicle battery 250. The motor ECU adjusts a duty ratio of a PWM signal which is given to the traveling motor in accordance with information input from the second controller 160 or information input from the driving operator 80 and outputs a travel driving power (torque) for traveling the vehicle M using the traveling motor. For example, the motor ECU may perform charging by returning electricity generated through forcible rotation of the traveling motor at the time of rotating wheels after detachment of an accelerator to the vehicle battery 250.

The vehicle battery 250 supplies power for travel driving of the own vehicle M or power for operating air conditioning or the like inside the vehicle. The vehicle battery 250 is, for example, a secondary cell such as a lithium ion battery. As the vehicle battery 250, any vehicle battery can be used as long as charging and discharging can be performed. The vehicle battery 250 is charged or discharged, for example, by controlling the motor ECU that includes a traveling motor.

The power receiver 252 is used, for example, when the vehicle battery 250 is charged by a contactless scheme. The power receiver 252 wirelessly receives power in the charging and discharging space. The vehicle battery 250 is charged wirelessly by causing the own vehicle M to stop at a position at which the power receiver 252 can receive power in a contactless manner from the charging and discharging device provided in the charging and discharging space.

The charging and discharging connector 254 is used, for example, when the vehicle battery 250 is charged or discharged by a contact scheme. The charging and discharging connector 254 is a detachable connector which is connected to a charging and discharging plug of the charging and discharging device to acquire power to be supplied from the charging and discharging device installed in the charging and discharging space. For example, in a state in which the charging and discharging connector 254 is connected to the charging and discharging plug (a contact state) in a contact scheme, the vehicle battery 250 is charged or discharged. Attaching or detaching of the charging and discharging connector 254 to or from the charging and discharging plug may be performed automatedly by preparing for a mechanical configuration for approaching the charging and discharging plug to the charging and discharging connector 254.

The power transmitter 256 is used, for example, when the vehicle battery 250 is discharged by a contactless scheme. The power transmitter 256 wirelessly transmits power in the charging and discharging space. The power is wirelessly discharged from the vehicle battery 250 by causing the own vehicle M to stop at a position at which the power transmitter 256 can transmit power in a contactless manner to the charging and discharging device provided in the charging and discharging space.

The vehicle system 1 according to the embodiment may be configured to be provided in one of the charging and discharging connector 254 and a set of the power receiver 252 and the power transmitter 256.

The brake device 210 includes, for example, a brake caliper, a cylinder that transmits a hydraulic pressure to the brake caliper, an electric motor that generates a hydraulic pressure to the cylinder, and a brake ECU. The brake ECU controls the electric motor in accordance with information input from the second controller 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second controller 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second controller 160 or information input from the driving operator 80.

### [Parking Lot]

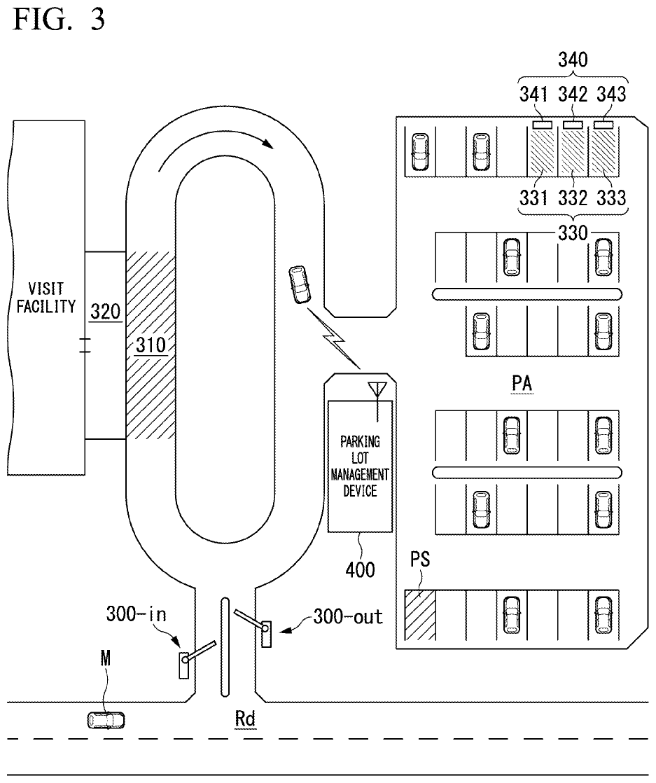

FIG. 3 is a diagram schematically illustrating a parking lot. In a route reaching from a road Rd to a visit facility, gates 300-in and 300-out are provided. The stopping area 310 faces the boarding area 320 connected to the visit facility. In a boarding area 320, an eave is provided to block rain and snow.

For example, a charging and discharging space 330 is provided in the parking lot. The charging and discharging space 330 includes, for example, a plurality of charging and discharging spaces 331, 332, and 333. In the charging and discharging space 330, a charging and discharging device 340 is provided. The charging and discharging device 340 may be included in, for example, a configuration of the parking lot management device 400 to be described below. For example, the charging and discharging devices 341, 342, and 343 are installed in the charging and discharging spaces 331, 332, and 333, respectively. The charging and discharging device 340 is connected to a power system and can transmit and receive power to and from a vehicle parked in the parking lot. For example, the charging and discharging device 340 transmits and receives power to and from a vehicle parked in the charging and discharging space 330 by using a wireless power transmission technology. The present invention is not limited thereto. The charging and discharging device 340 may include a charging and discharging plug and may be connected to the charging and discharging connector 254 of the own vehicle M to transmit and receive power.

The charging and discharging device 340 may transmit power transmitted from one vehicle to another vehicle by using a wireless power transmission technology. For example, the charging and discharging device 341 outputs power transmitted from a first vehicle parked in the charging and discharging space 331 to the charging and discharging device 342. The charging and discharging device 342 transmits power input from the charging and discharging device 341 to a second vehicle parked in the charging and discharging space 332.

### [Autonomous Parking Event: At Time of Entrance (No Autonomous Charging)]

For example, the autonomous parking controller 141 parks the own vehicle M in a parking space based on information received from a parking lot management device 400 through the communication device 20. Hereinafter, a case in which a charging instruction is not received from a user alighting in the stopping area 310 will be described.

After an occupant alights from a vehicle in the stopping area 310, the own vehicle M performs unmanned automated driving and starts an autonomous parking event for moving to the parking space PS in the parking lot PA. A trigger to start the autonomous parking event may be, for example, any operation by a user of the own vehicle M, a user using a terminal device of an owner, or the owner or may be wireless reception of a predetermined signal from the parking lot management device 400.

For example, when an automated parking request is received using a terminal device from a user of the own vehicle M, the parking lot management device 400 instructs the own vehicle M to start an automated parking event based on information received from the terminal device and performs guiding for automated parking. The present invention is not limited thereto and the automated parking request may be received using the HMI 30. For example, when the automated parking request is received using the HMI 30 from the user of the own vehicle M, the own vehicle M starts the automated parking event and the parking lot management device 400 performs guiding for automated parking.

When an autonomous parking event starts, the autonomous parking controller 141 controls the communication device 20 such that a parking request is transmitted to the parking lot management device 400. Then, the own vehicle M moves while performing sensing by itself from the stopping area 310 to the parking lot PA in accordance with guiding of the parking lot management device 400. For example, a route to a target parking position is instructed from the parking lot management device 400 and the own vehicle M travels while performing sensing by itself along the route instructed by the parking lot management device 400.

When the autonomous parking event starts, the upload manager 150 transmits information indicating a remaining energy amount of the vehicle battery 250 acquired by the remaining amount manager 170 to the parking lot management device 400 by using the communication device 20.

### [Autonomous Charging Event and Autonomous Parking Event: At Time of Entrance (Autonomous Charging)]

Next, a case in which a user alighting in the stopping area 310 gives a charging instruction will be described. The own vehicle M starts an autonomous charging event in which unmanned automated driving is performed and the own vehicle M moves to the charging and discharging space 330 in the parking lot PA after an occupant alights in the stopping area 310. A trigger to start the autonomous charging event may be any operation by the user using a terminal device of the user of the own vehicle M or may be wireless reception of a predetermined signal from the parking lot management device 400.

For example, when a request for charging while parked is received using the terminal device from the user of the own vehicle M, the parking lot management device 400 instructs the own vehicle M to start the autonomous charging event based on the information received from the terminal device and performs guidance for automated parking in the charging and discharging space 330. The present invention is not limited thereto and the request for charging while parked may be received using the HMI 30. For example, when the request for charging while parked is received using the HMI 30 from the user of the own vehicle M, the own vehicle M starts the autonomous charging event and the parking lot management device 400 performs guidance for automated parking in the charging and discharging space 330.

When the autonomous charging event starts, the autonomous charging and discharging controller 142 controls the communication device 20 and transmits a charging request to the parking lot management device 400. Then, the own vehicle M moves while performing sensing by itself from the stopping area 310 to the charging and discharging space 330 in accordance with guidance of the parking lot management device 400. For example, the parking lot management device 400 gives an instruction of a route to the target charging and discharging space 330 and the own vehicle M travels while performing sensing by itself along the route instructed by the parking lot management device 400.

When the autonomous charging event starts, the upload manager 150 transmits information indicating a remaining energy amount of the vehicle battery 250 acquired by the remaining amount manager 170 to the parking lot management device 400 by using the communication device 20. The parking lot management device 400 determines a charging amount of the own vehicle M with reference to the received information indicating the remaining energy amount, management information stored in the own storage 430, and the like. When the own vehicle M is parked in the charging and discharging space 330, the parking lot management device 400 controls the charging and discharging device 340 such that the own vehicle M is charged with power of the determined charging amount. When the charging of the vehicle battery 250 is completed, the own vehicle M performs unmanned automated driving and starts the autonomous parking event for moving to the parking space PS in the parking lot PA.

### [Autonomous Parking Event: At Time of Return]

The autonomous parking controller 141 and the communication device 20 maintain an operation state even while the own vehicle M is parked. For example, when a pickup request from a terminal device of a user is received, for example, a route generator 421 of the parking lot management device 400 generates a route from the parking space PS to the stopping area 310 and transmits the route to the own vehicle M. When the route is received, the autonomous parking controller 141 of the own vehicle M activates a system of the own vehicle M and causes the own vehicle M to move to the stopping area 310 along the route. At this time, an inter-vehicle adjuster 422 of the parking lot management device 400 instructs a specific vehicle to stop or move slowly, for example, as necessary based on a positional relation between a plurality of vehicles so that the vehicles do not simultaneously enter to the same position, as in the time of entrance. When the own vehicle M is caused to move to the stopping area 310 and picks up the occupant, the autonomous parking controller 141 stops the operation. Thereafter, manual driving or automated driving by another functional unit starts.

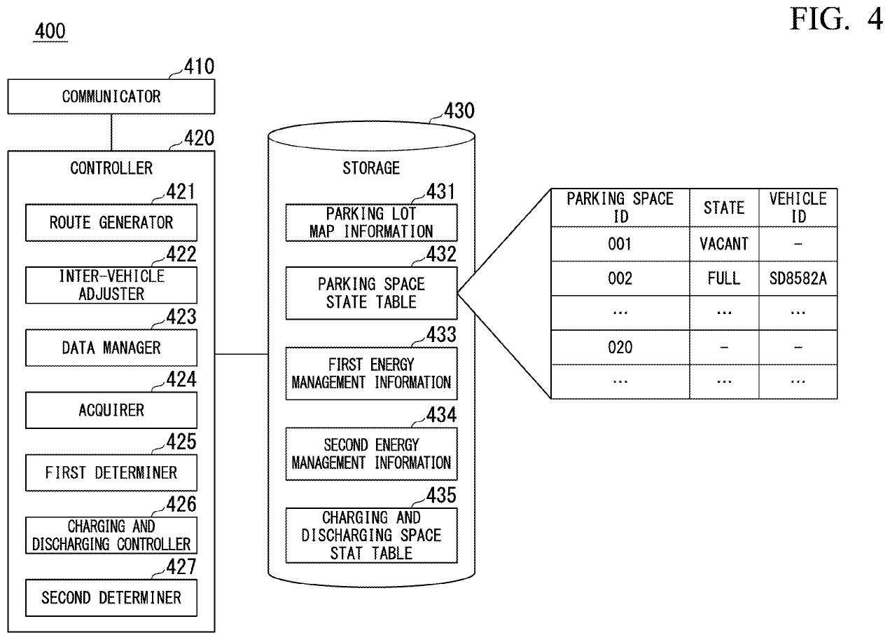

FIG. 4 is a diagram illustrating an example of a configuration of the parking lot management device 400. The parking lot management device 400 includes, for example, a communicator 410, a controller 420, and a storage 430. Although not illustrated, the parking lot management device 400 includes a power source device connected to a power system and operates based on power from the power system. The storage 430 includes information such as parking lot map information 431, a parking space state table 432, first energy management information 433, second energy management information 434, and a charging and discharging space state table 435.

The communicator 410 wirelessly communicates with other vehicles and the own vehicle M. The controller 420 includes, for example, the route generator 421, the inter-vehicle adjuster 422, a data manager 423, an acquirer 424, a first determiner 425, a charging and discharging controller 426, and a second determiner 427. The charging and discharging controller 426 is an example of a “replenisher.” When the charging and discharging device 340 is included in the configuration of the parking lot management device 400, a combination of the charging and discharging controller 426 and the charging and discharging device 340 is an example of the “replenisher.”

The route generator 421 determines the charging and discharging space 330 or the parking space PS in which a vehicle is allowed to park based on information acquired by the communicator 410 and information stored in the storage 430 and guides the vehicle to the determined parking space PS or charging and discharging space 330. The parking lot map information 431 is information indicating the structure of the parking lot PA geometrically. The parking lot map information 431 includes coordinates of each parking space PS. In the parking space state table 432, for example, a state which indicates a vacant state or a full (parking) state and a vehicle ID which is identification information of a vehicle which is parked in the case of the full state are associated with a parking space ID which is identification information of the parking space PS. In the charging and discharging space state table 435, for example, a state which indicates a vacant state or a full (parking) state and a vehicle ID which is identification information of a vehicle which is parked in the case of the full state are associated with a charging and discharging space ID which is identification information of the charging and discharging space 330.

When the communicator 410 receives a parking request from a vehicle, the route generator 421 extracts the parking space PS of which a state is a vacant state with reference to the parking space state table 432, acquires a position of the extracted parking space PS from the parking lot map information 431, generates an appropriate route to the acquired position of the parking space PS, and transmits information indicating the generated route to the vehicle by using the communicator 410. When the communicator 410 receives a charging request from the vehicle, the route generator 421 extracts the charging and discharging space 330 of which a state is a vacant state with reference to the charging and discharging state table 435, acquires a position of the extracted charging and discharging space 330 from the parking lot map information 431, generates an appropriate route to the acquired charging and discharging space 330, and transmits information indicating the generated route to the vehicle by using the communicator 410.

The inter-vehicle adjuster 422 instructs a specific vehicle to stop or move slowly, for example, as necessary based on a positional relation between a plurality of vehicles so that the vehicles do not simultaneously advance to the same position.

In a vehicle receiving the route (hereinafter assumed to be the own vehicle M), the autonomous parking controller 141 generates a target trajectory based on the route. When the own vehicle M approaches the parking space PS or the charging and discharging space 330 which is a target, the parking space recognizer 131 recognizes a parking frame line or the like marking each space, recognizes a detailed position of each space, and supplies the detailed position of each space to the autonomous parking controller 141. The autonomous parking controller 141 receives the detailed position of each space, corrects the target trajectory, and causes the own vehicle M to park in the parking space PS or the charging and discharging space 330.

The data manager 423 stores information received from the own vehicle M by using the communicator 410 in the storage 430. The data manager 423 stores information received from the charging and discharging device 340 by using the communicator 410 in the storage 430. The data manager 423 also stores information derived on the basis of the received information in the storage 430.

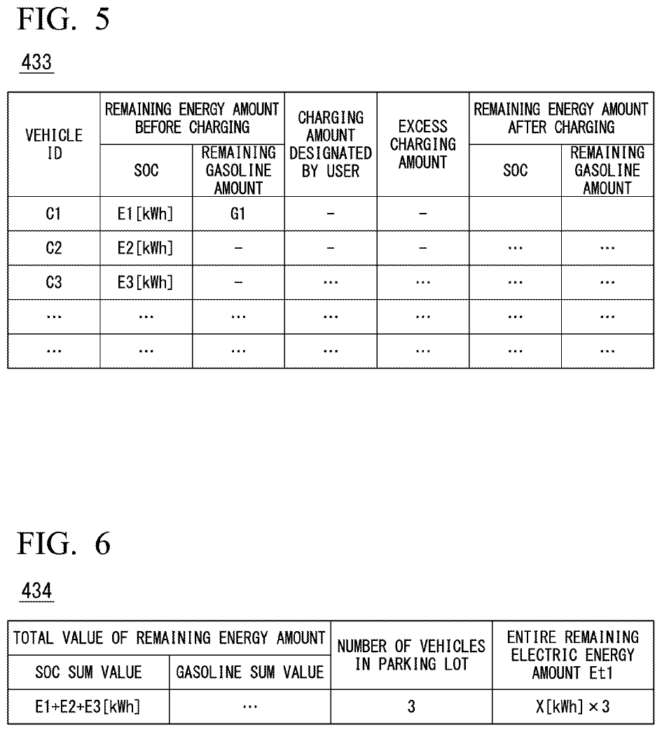

For example, the data manager 423 stores information or the like received from the own vehicle M in the first energy management information 433. FIG. 5 is a diagram illustrating an example of the first energy management information 433. The first energy management information 433 is, for example, information in which a pre-charging remaining energy amount, a charging amount designated by a user, an excess charging amount, and a post-charging remaining energy amount are associated with a vehicle ID. The vehicle ID is identification information for identifying each vehicle. The pre-charging remaining energy amount is a remaining energy amount of each vehicle before the vehicle is charged by the charging and discharging device 340. The post-charging remaining energy amount is a remaining energy amount of each vehicle after the vehicle is charged by the charging and discharging device 340. The remaining energy amount includes an SOC indicating a remaining amount of the vehicle battery 250 and a remaining gasoline amount indicating a remaining amount of gasoline. The charging amount designated by a user is a charging amount designated in a charging request by the user. The excess charging amount is an additional charging amount with which a vehicle is charged in addition to the charging amount designated by the user.

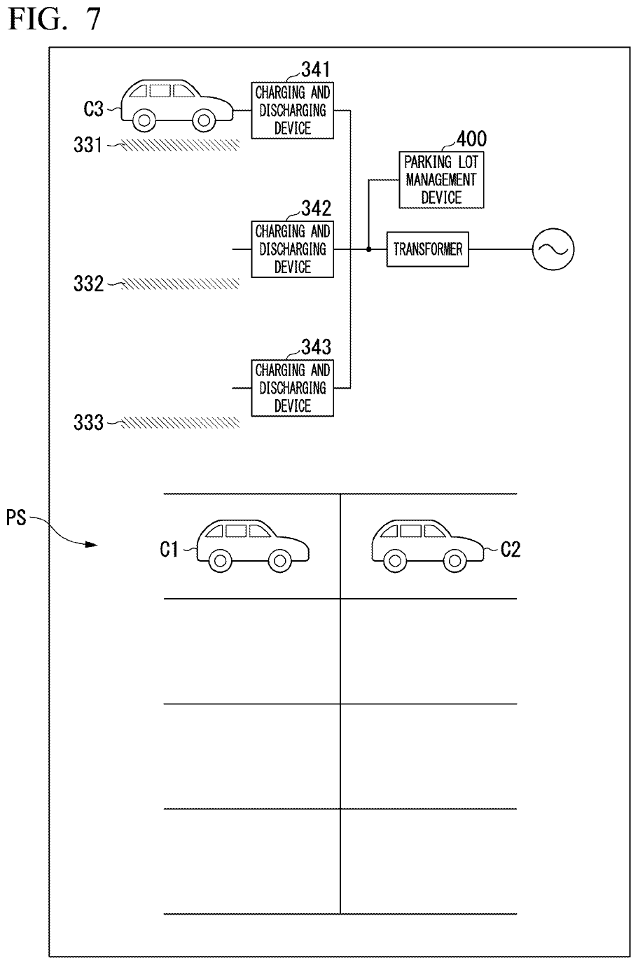

The data manager 423 stores information or the like received from the own vehicle M in the second energy management information 434. FIG. 6 is a diagram illustrating an example of the second energy management information 434. In the second energy management information 434 for example, the number of vehicles in the parking lot and an entire remaining energy amount Et1 are associated with a total value of a remaining energy amount. The total value of the remaining energy amount is a sum value of a remaining energy amount of the entire parking lot and includes, for example, an SOC sum value and a gasoline sum value. The SOC sum value is a sum value of SOCs of all the vehicles which are parked in the parking lot. The gasoline sum value is a sum value of remaining gasoline amounts of all the vehicles which are parked in the parking lot. The entire remaining energy amount Et1 will be described below and is, for example, the number of vehicles in a parking lot of a minimum power amount Xx necessary for a return.

The acquirer 424 acquires information indicating a remaining energy amount of each target vehicle (hereinafter referred to as a first remaining energy amount) among the vehicles parked in the parking lot. The target vehicle is a vehicle of which a remaining energy amount can be managed by the parking lot management device 400. For example, target vehicles include a vehicle of which charging is requested by the user during valet parking and a vehicle of which power of the vehicle battery 250 is permitted to be supplied to another vehicle by the user. The remaining energy amount includes a remaining amount of the vehicle battery 250 and a remaining amount of fuel of each vehicle. The acquirer 424 may receive information indicating the remaining energy amount from the own vehicle M by using the communicator 410 or may receive the information from the charging and discharging device 340 by using the communicator 410.

For example, when a parking request is received from the user who alights and a charging event starts, the acquirer 424 acquires information indicating the first remaining energy amount from a vehicle to which the charging request is made.

The first determiner 425 determines the remaining energy amount of the vehicles parked in the parking lot so that a sum of remaining energy amounts of target vehicles among the vehicles parked in the parking lot is equal to or greater than a predetermined value. The predetermined value is, for example, a value with which the parking lot management device 400 is operable when the parking lot management device 400 guides the vehicles parked in the parking lot in a state in which supply of power from the power system is stopped. The predetermined value may be a value sufficient for each vehicle to exit and travel outside the parking lot when the remaining energy amount of the vehicles parked in the parking lot is distributed among the vehicles. The details thereof will be described later.

When the supply of power from the power system is stopped, the second determiner 427 determines a vehicle which is a power supply side (a first vehicle) or an amount of power to be discharged to the first vehicle. When the supply of power from the power system is stopped, the charging and discharging controller 426 controls the charging and discharging device 340 such that the power with which the vehicle battery 250 of the first vehicle is charged is discharged and acquires the power discharged from the vehicle. The power acquired by the charging and discharging controller 426 is used, for example, for the controller 420 to perform a process of guiding a vehicle parked in the parking lot toward an exit.

When the supply of power from the power system is stopped, the second determiner 427 may determine a vehicle which is a power reception side (a second vehicle) or an amount of power or the like with which the second vehicle is charged.

The charging and discharging controller 426 replenishes energy to the vehicles in the parking lot based on one or both of the remaining energy amount determined by the first determiner 425 or the amount of power determined by the second determiner 427. The charging and discharging controller 426 controls the charging and discharging device 340 such that the power based on the remaining energy amount determined by the first determiner 425 is moved from the first vehicle which is a power supply side to the second vehicle which is a power reception side. The details thereof will be described later.

### [Details of First Determiner]

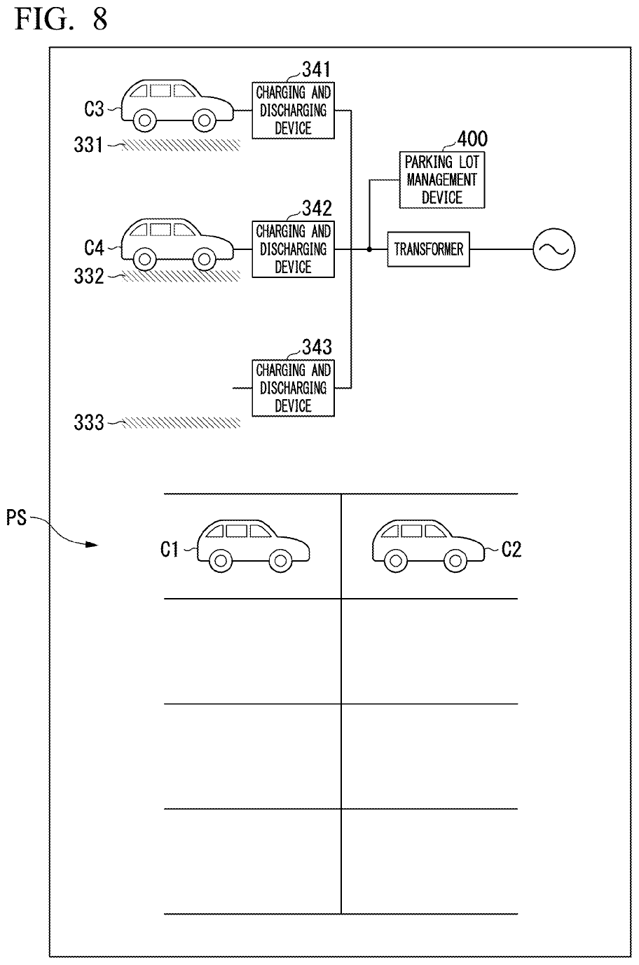

FIG. 7 is a diagram illustrating an example of a parking situation (part 1) of the parking lot PA. In the parking situation (part 1), vehicles C1 and C2 are parked in the parking space PS and a vehicle C3 is parked in the charging and discharging space 331. The vehicles C1 and C2 are waiting to be returned. The vehicle C3 is a vehicle of which charging is instructed from a user. The parking lot management device 400 has already communicated at the time of entrance of the vehicles C1 to C3 and stores a remaining electric energy amount and a remaining gasoline amount of each vehicle in the pre-charging remaining energy amount of the first energy management information 433.

For example, it is assumed that E1 is a remaining electric energy amount of the vehicle C1, E2 is a remaining electric energy amount of the vehicle C2, and E3 is a remaining electric amount of the vehicle C3. The vehicle C1 is a hybrid vehicle and G1 is a remaining gasoline amount. In this case, the first determiner 425 derives a sum value of remaining electric energy amounts (hereinafter a sum value Et0 of actual remaining electric energy amounts)=E1+E2+E3 of all the vehicles C1 to C3 parked in the parking lot PA with reference to the first energy management information 433. The data manager 423 writes the sum value Et0 of the actual remaining electric energy amount derived by the first determiner 425 in a field of the SOC sum value of the second energy management information 434. The data manager 423 writes the remaining gasoline amount G1 in a field of the gasoline sum value of the second energy management information 434.

Subsequently, the first determiner 425 determines a target remaining electric energy amount of the entire parking lot (hereinafter referred to as an entire remaining electric energy amount Et1). The entire remaining electric energy amount Et1 is a remaining electric energy amount which is ensured in the entire parking lot in the event of an emergency such as supply of power from the power system being stopped. The entire remaining electric energy amount Et1 includes, for example, a total amount of power necessary to operate a parking facility to return all the vehicles which are parked (hereinafter referred to as a total operation energy amount). The total operation energy amount includes, for example, an amount of power necessary for the parking lot management device 400 to communicate with a communication facility such as cameras installed in the parking lot or each vehicle or the like which is parked and an amount of power necessary for the parking lot management device 400 to perform information processing to guide a parked vehicle toward an exit.

The entire remaining electric energy amount Et1 may include a total amount of power sufficient for each vehicle to exit and travel outside of the parking lot PA (hereinafter referred to as a total traveling energy amount) when the remaining energy amount of the vehicles parked in the parking lot PA is distributed among the vehicles. The total traveling energy amount may be, for example, a total amount of power sufficient for all the vehicles which are parked to exit and travel or may be a total amount of power sufficient for vehicles which are parked except for vehicles which can exit using a combustible fuel such as gasoline (for example, diesel fuel, ethanol, liquefied petroleum gas (LPG), compressed natural gas (CNG), or hydrogen) to exit and travel.

For example, the first determiner 425 derives an electric energy amount Et1(A) which is an example of the total operation energy amount and determines the derived electric energy amount Et1(A) as the entire remaining electric energy amount Et1. The electric energy amount Et1(A) is, for example, an amount of power necessary for the parking lot management device 400 parked in the parking lot to guide all the vehicles C1 to C3 toward an exit.

Here, when a vehicle such as the vehicle C1 which can generate power using a combustible fuel such as gasoline is included and a remaining amount of combustible fuel such as gasoline of the vehicle C1 is not zero, the first determiner 425 may derive an amount of power generated in the vehicle C1 based on the remaining amount G1 of the combustible fuel such as gasoline.

The present invention is not limited thereto. The first determiner 425 may derive, for example, an electric energy amount Et1(B) which is an example of a total traveling energy amount. The electric energy amount Et1(B) is, for example, an amount of power necessary for all the vehicles C1 to C3 parked in the parking lot to return and travel to the stopping area 310. The first determiner 425 may determine a sum value of the derived electric energy amount Et1(A) and electric energy amount Et1(B) as the entire remaining electric energy amount Et1.

Here, when a vehicle such as the vehicle C1 which can travel using gasoline is included and a remaining amount of gasoline of the vehicle C1 is not zero, the first determiner 425 determines whether the vehicle C1 can return and travel to the stopping area 310 based on the remaining gasoline amount G1. When the vehicle C1 can return and travel to the stopping area 310, the first determiner 425 may derive an electric energy amount with which the vehicles C2 and C3 other than the vehicle C1 can return and travel to the stopping area 310 and may determine the entire remaining electric energy amount Et1 based on the derived electric energy amount.

Subsequently, the first determiner 425 determines a remaining energy amount after charging of a vehicle of which charging is instructed from the user (hereinafter referred to as post-charging remaining energy amount Ec). For example, the first determiner 425 determines a post-charging remaining energy amount Ec3 of the vehicle C3 based on a difference between the “entire remaining electric energy amount Et1” and the “sum value Et0 of the actual remaining electric energy amount.”

For example, based on a pre-charging remaining electric energy amount E3 of the vehicle C3, the first determiner 425 determines whether the vehicle battery 250 of the vehicle C3 can be charged with power Ed of the difference. When the first determiner 425 determines that the vehicle battery 250 of the vehicle C3 can be charged with the power Ed of the difference, the first determiner 425 determines the power Ed of the difference as the post-charging remaining energy amount Ec3 of the vehicle C3. Thus, power used in the parking lot PA can be ensured by utilizing the batteries of the vehicle which are parked in the parking lot.

The determined post-charging remaining energy amount Ec may be equal to or greater than a charging amount instructed from the user. In this case, a fee of the amount of power charged over the charging amount instructed from the user (hereinafter referred to as an excess charging amount) is not paid to the user. Thus, when vehicles of which charging is instructed from users are charged with amounts of power instructed from the users, the power used in the parking lot can be charged at the same timing.

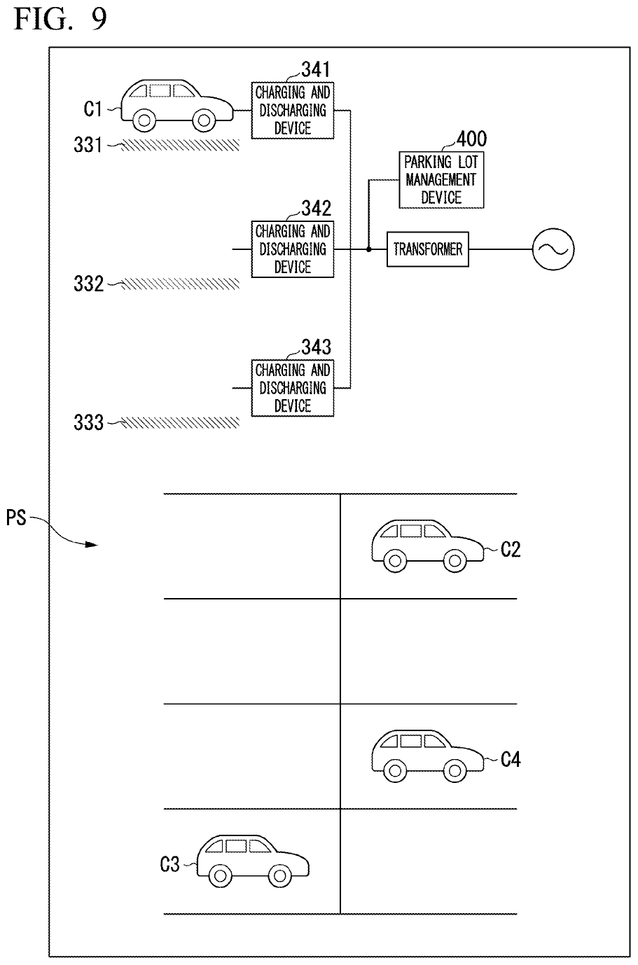

Conversely, when the first determiner 425 determines that the vehicle battery 250 of the vehicle C3 cannot be charged with power Ed of the difference, the first determiner 425 causes the vehicle battery 250 of the vehicle C4 in addition to the vehicle battery 250 of the vehicle C3 to be charged with the power Ed of the difference. The vehicle C4 is a vehicle which enters the parking PA after the vehicle C3 in response to a charging instruction from the user. FIG. 8 is a diagram illustrating an example of a parking situation (part 2) of the parking lot PA. In the parking situation (part 2), the vehicles C1 and C2 are parked in different parking spaces PS, the vehicle C3 is parked in the charging and discharging space 331, and a vehicle C4 is parked in the charging and discharging space 332.

For example, based on the pre-charging remaining electric energy amount E3 of the vehicle C3 and the pre-charging remaining electric energy amount E4 of the vehicle C4, the first determiner 425 determines whether the vehicle battery 250 of the vehicle C3 and the vehicle battery 250 of the vehicle C4 can be charged with the power Ed of the difference. When the first determiner 425 determines that the vehicle battery 250 of the vehicle C3 and the vehicle battery 250 of the vehicle C4 can be charged with the power Ed of the difference, the first determiner 425 determines the power Ed of the difference as the post-charging remaining energy amounts Ec of the vehicles C3 and C4. The details of the post-charging remaining energy amounts Ec of the vehicles C3 and C4 (that is, the post-charging remaining energy amount Ec3 corresponding to the vehicle C3 and the post-charging remaining energy amount Ec4 corresponding to the vehicle C4) may be the same or may be different in accordance with an SOC of each vehicle. When the details of the post-charging remaining energy amounts Ec of the vehicles C3 and C4 are determined, the first determiner 425 may cause the vehicle battery 250 with higher charging and discharging efficiency (or a lower degree of deterioration) to be charged with more power than the vehicle battery 250 with lower charging and discharging efficiency (or a higher degree of deterioration) based on the charging and discharging efficiency, the degree of deterioration of each vehicle, or the like.

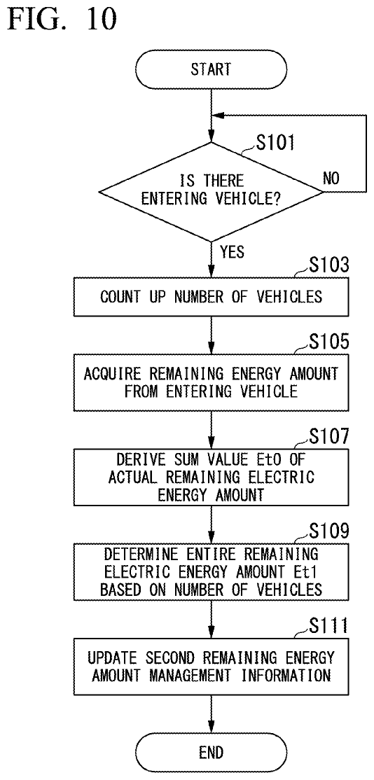

Conversely, when the first determiner 425 determines that the vehicle battery 250 of the vehicle C3 and the vehicle battery 250 of the vehicle C4 cannot be charged with the power Ed of the difference even with use of both the vehicle battery of the vehicle C3 and the vehicle battery of the vehicle C4, the first determiner 425 causes the vehicle battery of the vehicle C1 which is parked to be further charged with the power Ed of the difference. The vehicle C1 is, for example, a vehicle which has not been charged by the charging and discharging device 340 at the time of entrance. Alternatively, the vehicle C1 is a vehicle that has a lower SOC than the vehicle C2. FIG. 9 is a diagram illustrating an example of a parking situation (part 3) of the parking lot PA. In the parking situation (part 3), the vehicles C2 to C4 are parked in the parking space PS and the vehicle C1 is parked in the charging and discharging space 331.

For example, the first determiner 425 determines the power Ed of the difference as the post-charging remaining energy amounts Ec of the vehicles C1, C3, and C4. The details of the post-charging remaining energy amounts Ec of the vehicles C1, C3, and C4 (that is, the post-charging remaining energy amount Ec1 corresponding to the vehicle C1, the post-charging remaining energy amount Ec3 corresponding to the vehicle C3, and the post-charging remaining energy amount Ec4 corresponding to the vehicle C4) may be the same or may be different in accordance with an SOC of each vehicle. When the details of the post-charging remaining energy amounts Ec of the vehicles C1, C3, and C4 are determined, the first determiner 425 may cause the vehicle battery 250 with higher charging and discharging efficiency (or a lower degree of deterioration) to be charged with more power than the vehicle battery 250 with lower charging and discharging efficiency (or a higher degree of deterioration) based on the charging and discharging efficiency, the degree of deterioration of each vehicle, or the like.

Thus, even when power used in the parking lot cannot be ensured only with the batteries of the vehicles of which charging is instructed from the users, power used in the parking lot can be ensured by utilizing the batteries of the vehicles of which charging is not instructed from the users.

The vehicle C1 which is a vehicle waiting in the parking space PS and moving from the parking space PS to the charging and discharging space 330 to be charged may be a vehicle extracted by the first determiner 425, as will be described below. For example, when the power Ed of the difference obtained by subtracting the “sum value Et0 of the actual remaining electric energy amount” from the “entire remaining electric energy amount Et1” is equal to or greater than a threshold, the first determiner 425 extracts the vehicles of which charging is not instructed from the users. The first determiner 425 extracts vehicles of which the remaining energy amount is the smallest among the vehicles which are parked in the parking lot PA.

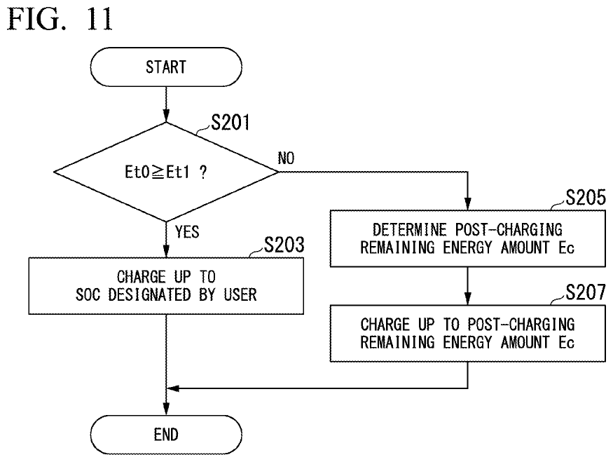

FIG. 10 is a diagram illustrating an example of an entering process by the parking lot management device 400. First, the data manager 423 determines whether there is an entering vehicle (step S101). When there is an entering vehicle, the data manager 423 counts up the number of vehicles in the parking lot of the second energy management information 434 (step S103). Then, the acquirer 424 acquires information indicating the first remaining energy amount from the entering vehicle (step S105) and the data manager 423 updates the first energy management information 433. Subsequently, the first determiner 425 derives the sum value Et0 of the actual remaining electric energy amount with reference to the first energy management information 433 (step S107) and determines the entire remaining electric energy amount Et1 (step S109). Then, the data manager 423 writes the sum value Et0 of the actual remaining electric energy amount and the entire remaining electric energy amount Et1 in the second energy management information 434.

FIG. 11 is a diagram illustrating an example of a charging process by the parking lot management device 400. The first determiner 425 determines whether the sum value Et0 of the actual remaining electric energy amount is equal to or greater than the entire remaining electric energy amount Et1 (step S201). When the sum value Et0 of the actual remaining electric energy amount is equal to or greater than the entire remaining electric energy amount Et1, the charging and discharging controller 426 controls the charging and discharging device 340 such that the vehicle parked in the charging and discharging space 330 is charged up to an SOC designated by the user (step S203).

Conversely, when the sum value Et0 of the actual remaining electric energy amount is not equal to or greater than the entire remaining electric energy amount Et1 in step S201, the first determiner 425 determines the post-charging remaining energy amount Ec based on a difference between the “entire remaining electric energy amount Et1” and the “sum value Et0 of the actual remaining electric energy amount” (step S205). Then, the charging and discharging controller 426 controls the charging and discharging device 340 such that the vehicle parked in the charging and discharging space 330 is charged up to the post-charging remaining energy amount Ec determined by the first determiner 425 (step S207).

In the above-described processes, the example in which the vehicle parked in the charging and discharging space 330 is charged up to an SOC designated by the user or the post-charging remaining energy amount Ec determined by the first determiner 425 has been described. However, in addition to this, the charging and discharging controller 426 controls the charging and discharging device 340 or the like such that entire energy replenishment may be performed in consideration of a remaining amount or the like of combustible fuel of the parked vehicles.

### [Case in Which Supply of Power is Stopped (Part 1)]

For example, supply of power from the power system is assumed to be stopped in a state in which all the vehicles are parked in the parking space PS. In this case, the parking lot management device 400 determines the first vehicle which is caused to supply power to the parking lot management device 400 among the vehicles which are parked. The parking lot management device 400 guides the determined first vehicle to the charging and discharging space 330 and controls the charging and discharging device 340 such that a process of returning a vehicle in the parking lot is performed by using the power transmitted from the first vehicle.

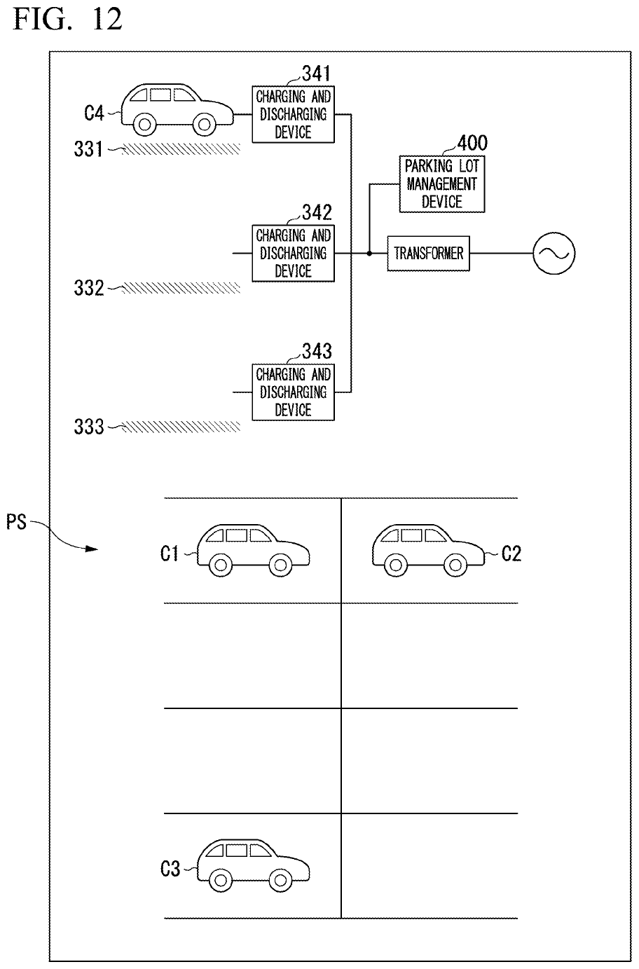

FIG. 12 is a diagram illustrating an example of movement of a vehicle when power supply is stopped. Although not illustrated, when the supply of the power from the power system is stopped, all the vehicles C1 to C4 are assumed to wait in the parking space PS. The second determiner 427 of the parking lot management device 400 determines the vehicle C4 as the first vehicle. Then, the vehicle C4 travels while performing sensing by itself to the charging and discharging space 331 to be parked in accordance with guidance of the parking lot management device 400. The charging and discharging controller 426 communicates with the vehicle C4 by using the communicator 410 to give a discharging instruction. The charging and discharging controller 426 controls the charging and discharging device 341 such that power discharged from the vehicle C4 is output to the charging and discharging device 343. Then, the charging and discharging controller 426 controls the charging and discharging device 343 such that the power input from the charging and discharging device 341 is output to the parking lot management device 400. The parking lot management device 400 includes a power buffer that guides several vehicles to the charging and discharging space 331 even when the supply of the power to the parking lot management device 400 is stopped. Thus, even when the charging and discharging space 331 is a parking lot in which there is only one vehicle, the control can be continued even at the time of switching of the vehicle which performs discharging.

The second determiner 427 determines, for example, vehicles with the highest SOC among the vehicles which are parked in the parking lot PA as the first vehicles. For example, the second determiner 427 may determine vehicles of which a parking time is the longest among the vehicles which are parked in the parking lot PA as the first vehicles. Thus, it is possible to limit the number of first vehicles which request supply of power to as small a value as possible.

The second determiner 427 may determine a plurality of vehicles as the first vehicles. Thus, by increasing the first vehicles which are discharging sides, causing traveling energy for returns to remain, and supplying the power of the vehicle batteries to the parking lot management device 400, it is possible to avoid a situation in which the first vehicles which are the discharging sides cannot return. In this case, for example, the second determiner 427 determines the first vehicles in order of a higher SOC among the vehicles which are parked in the parking lot PA. For example, the second determiner 427 may determine the first vehicles in order of a longer parking time among the vehicles which are parked in the parking lot PA. Thus, the vehicles of which the remaining energy amount is great can be determined as the first vehicles.

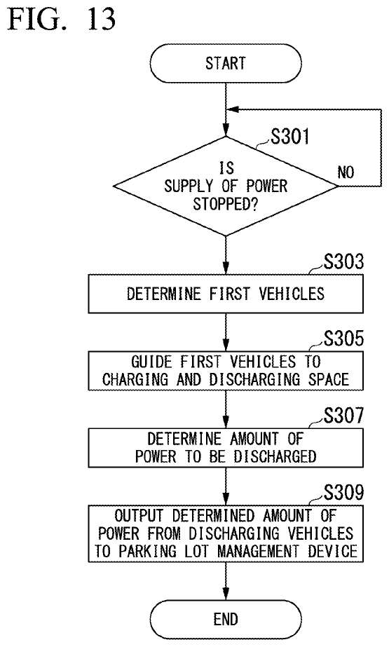

FIG. 13 is a diagram illustrating an example of a charging process by the parking lot management device 400. First, the second determiner 427 determines whether the supply of the power from the power system is stopped (step S301). When the supply of the power from the power system is stopped, the second determiner 427 determines the first vehicle among the vehicles which are parked (step S303). The route generator 421 determines the charging and discharging space 330 in which the first vehicles are allowed to be parked and guides the first vehicles to the determined charging and discharging space 330 (step S305). The second determiner 427 determines the amount of power discharged from the first vehicles based on the remaining energy amounts of the first vehicles (step S307). The charging and discharging controller 426 controls the charging and discharging device 340 such that the determined amount of power is output from the first vehicles to the parking lot management device 400 (step S309). When the first vehicles are vehicles which can generate power using gasoline in S307, the second determiner 427 may include the amount of power generated in the vehicle C1 based on the remaining gasoline amount G1 in the remaining energy amount of the first vehicles.

### [Case in Which Supply of Power is Stopped (Part 2)]

For example, the supply of the power from the power system is assumed to be stopped in a state in which all the vehicles are parked in the parking space PS. In this case, the parking lot management device 400 determines the first vehicles which are caused to supply power to the other vehicles among the vehicles which are parked. The parking lot management device 400 extracts vehicles which cannot return with the remaining energy amounts of the vehicles among the vehicles which are parked and determines the vehicles as the second vehicles which are sides to which the power is supplied. The parking lot management device 400 guides the determined first and second vehicles to the charging and discharging space 330 and controls the charging and discharging device 340 such that the power transmitted from the first vehicles is transmitted to the second vehicles.

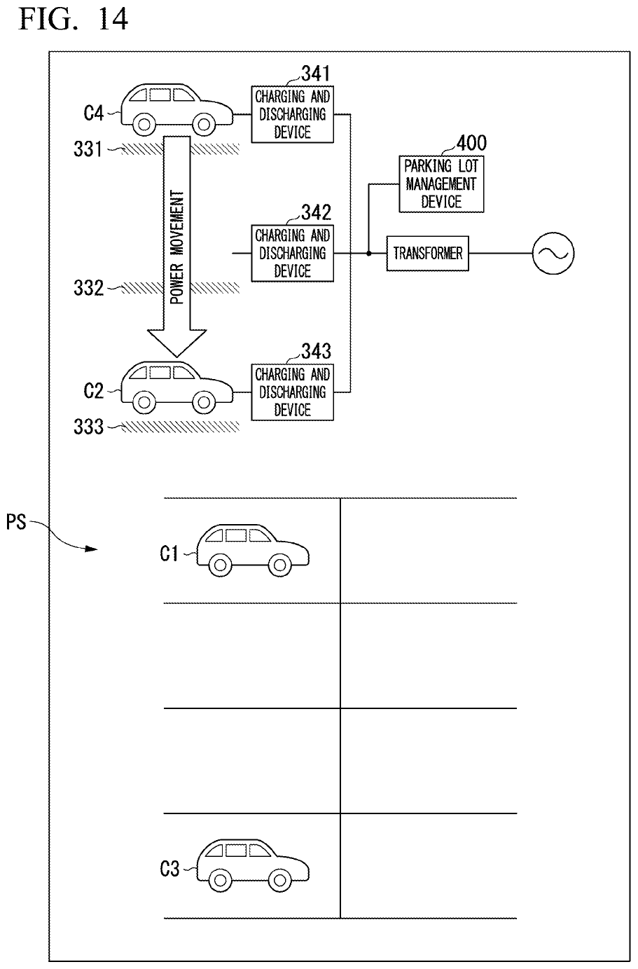

FIG. 14 is a diagram illustrating another example of the movement of the vehicle when the power supply is stopped. Although not illustrated, when the supply of the power from the power system is stopped, all the vehicles C1 to C4 are assumed to wait in the parking space PS. The second determiner 427 of the parking lot management device 400 determines the vehicle C4 as the first vehicle and determines the vehicle C2 as the second vehicle. Then, the vehicle C4 travels while performing sensing by itself to the charging and discharging space 331 to be parked in accordance with guiding of the parking lot management device 400. The vehicle C2 travels while performing sensing by itself to the charging and discharging space 333 to be parked in accordance with guiding of the parking lot management device 400. The charging and discharging controller 426 communicates with the vehicle C4 by using the communicator 410 to give a discharging instruction. The charging and discharging controller 426 controls the charging and discharging device 341 such that the power discharged from the vehicle C4 is output to the charging and discharging device 343. The charging and discharging controller 426 controls the charging and discharging device 343 such that the vehicle C2 is charged with the power input from the charging and discharging device 341. The parking lot management device 400 includes a power buffer that guides several vehicles to the charging and discharging space 331 even when the supply of the power to the parking lot management device 400 is stopped.

The second determiner 427 determines, for example, vehicles with the highest SOC among the vehicles which are parked in the parking lot PA as the first vehicles. For example, the second determiner 427 may determine vehicles of which a parking time is the longest among the vehicles which are parked in the parking lot PA as the first vehicles. Thus, it is possible to supply the power used for returns to more other vehicles.

The second determiner 427 may determine a plurality of vehicles as the first vehicles. Thus, it is possible to avoid a situation in which the number of first vehicles which are discharging sides is increased and the first vehicles which are discharging sides cannot be returned. In this case, for example, the second determiner 427 determines the first vehicles in order in which an SOC is higher among the vehicles which are parked in the parking lot PA. For example, the second determiner 427 may determine the first vehicles in order in which the parking time is the longest among the vehicles which are parked in the parking lot PA. Thus, the vehicles of which the remaining energy amount is much can be determined as the first vehicles.

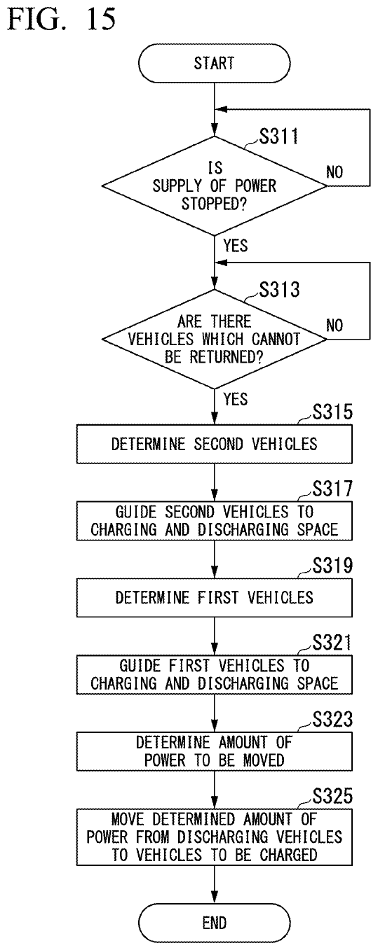

FIG. 15 is a diagram illustrating another example of the charging process by the parking lot management device 400. First, the second determiner 427 determines whether the supply of the power from the power system is stopped (step S311). When the supply of the power from the power system is stopped, the second determiner 427 determines whether vehicles which cannot be returned with the remaining energy amount of the vehicles are extracted (step S313). When the vehicles which cannot be returned with the remaining energy amount of the vehicle is extracted, the second determiner 427 determines the second vehicle among the extracted vehicles (step S315). The route generator 421 determines the charging and discharging space 330 in which the second vehicles are allowed to be parked and guides the second vehicles to the determined charging and discharging space 330 (step S317).

Subsequently, the second determiner 427 determines the first vehicles among the vehicles which are parked (step S319). The route generator 421 determines the charging and discharging space 330 in which the first vehicles are allowed to be parked and guides the first vehicles to the determined charging and discharging space 330 (step S321). The second determiner 427 determines the amount of power moved from the first vehicles to the second vehicles based on the remaining energy amount of the first vehicle and the remaining energy amount of the second vehicles (step S323). The charging and discharging controller 426 controls the charging and discharging device 340 such that the determined amount of power is moved from the first vehicles to the second vehicles (step S325).

### [Conclusion of Embodiment]

As described above, the parking lot management device 400 according to the embodiment includes: the acquirer 424 configured to acquire information indicating remaining energy amounts of vehicles parked in a parking lot; the first determiner 425 configured to determine a remaining energy amount of a vehicle parked in the parking lot so that a sum of the acquired remaining energy amounts is equal to or greater than a predetermined value; and a replenisher (for example, the charging and discharging controller 426 or the charging and discharging device 340) configured to replenish energy of the parked vehicle based on the determination. Thus, it is possible to manage charging and discharging of vehicles in consideration of the total amount of energy of vehicles in the parking lot.

### [Hardware Configuration]

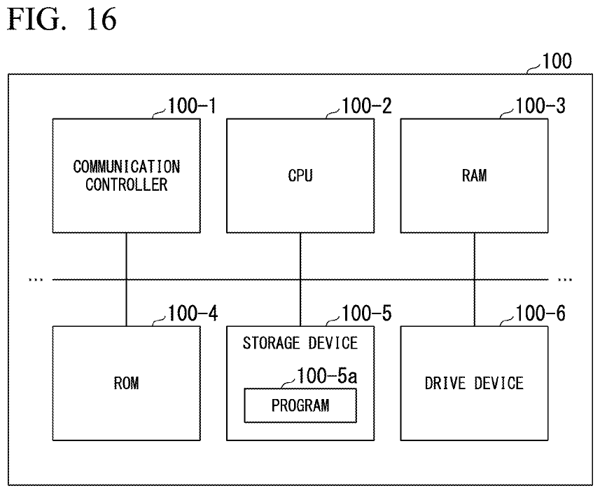

FIG. 16 is a diagram showing an example of a hardware configuration of the automated driving control device 100 according to an embodiment. As shown, the automated driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line. The communication controller 100-1 performs communication with constituent element other than the automated driving control device 100. The storage device 100-5 stores a program 100-5a that is executed by the CPU 100-2. The program is loaded on the RAM 100-3 by a direct memory access (DMA) controller (not shown) or the like to be executed by the CPU 100-2. Thus, some or all of the first controller 120 and the second controller 160 are realized.

The above-described embodiment can be expressed as follows:

a management device including a storage device that stores a program and a hardware processor, the hardware processor executing the program stored in the storage device to perform:

acquiring information indicating remaining energy amounts of vehicles parked in a parking lot;

determining a remaining energy amount of a vehicle parked in the parking lot so that a sum of the acquired remaining energy amounts is equal to or greater than a predetermined value; and

replenishing energy of the parked vehicle based on the determined remaining energy amount.

The embodiments for carrying out the present invention have been described above, but the present invention is not limited to the embodiments. Various modifications and substitutions can be made within the scope of the present invention without departing from the gist of the present invention.

What is claimed is:

1. A management device comprising:
an acquirer configured to acquire information indicating remaining energy amounts of vehicles parked in a parking lot;
a determiner configured to determine a remaining energy amount of a vehicle parked in the parking lot so that a sum of the acquired remaining energy amounts is equal to or greater than a predetermined value; and
a replenisher configured to replenish energy of the parked vehicle based on the remaining energy amount determined by the determiner.

2. The management device according to claim 1, wherein the predetermined value is a value with which the management device is able to operate by supplying energy from the vehicle parked in the parking lot to the management device when the management device guides the vehicle parked in the parking lot in a state in which supply power from a power system is stopped.

3. The management device according to claim 1, wherein the predetermined value is a value with which each of the vehicles parked in the parking lot is able to exit the parking lot and travel when energy related to the predetermined value is distributed among the vehicles parked in the parking lot.

4. The management device according to claim 1, wherein the determiner determines the predetermined value based on the number of vehicles parked in the parking lot.

5. The management device according to claim 1, further comprising:
a controller configured to control a charging and discharging device based on the remaining energy amount determined by the determiner,
wherein the charging and discharging device is connected to the power system and is able to receive and transmit power to and from the vehicles parked in the parking lot.

6. The management device according to claim 5,
wherein the controller controls the charging and discharging device such that power with which a battery of a first vehicle is charged is acquired when the supply of the power from the power system is stopped, and
wherein the management device performs a process of guiding the vehicles parked in the parking lot and causing the vehicles to exit using the acquired power.

7. The management device according to claim 5, wherein the controller controls the charging and discharging device such that a battery of a second vehicle is charged with power with which a battery of a first vehicle is charged when the supply of the power from the power system is stopped.

8. The management device according to claim 6, wherein the determiner determines the first vehicle in order from a vehicle with a longer parking time.

9. A management method causing a computer to perform:
acquiring information indicating remaining energy amounts of vehicles parked in a parking lot;
determining a remaining energy amount of a vehicle parked in the parking lot so that a sum of the acquired remaining energy amounts is equal to or greater than a predetermined value; and
replenishing energy of the parked vehicle based on the determined remaining energy amount.

10. A non-transitory computer-readable storage medium that stores a program causing a computer to perform:
acquiring information indicating remaining energy amounts of vehicles parked in a parking lot;
determining a remaining energy amount of a vehicle parked in the parking lot so that a sum of the acquired remaining energy amounts is equal to or greater than a predetermined value; and
replenishing energy of the parked vehicle based on the determined remaining energy amount.
